(19) United States
(12) Patent Application Publication
(10) Pub. No.: US 2013/0038149 A1
(43) Pub. Date: Feb. 14, 2013

(54) SILENCER MODULE FOR A GENERATOR COLLECTOR VENTILATION SYSTEM AND METHOD OF REDUCING A SOUND SIGNATURE OF A GENERATOR COLLECTOR

(71) Applicants: Richard Lynn Loud, Ballston Spa, NY (US); Albert Eugene Steinbach, Schenectady, NY (US); Etienne Mangin, Belfort (FR)

(72) Inventors: Richard Lynn Loud, Ballston Spa, NY (US); Albert Eugene Steinbach, Schenectady, NY (US); Etienne Mangin, Belfort (FR)

(73) Assignee: GENERAL ELECTRIC COMPANY, Schenectady, NY (US)

(21) Appl. No.: 13/208,466

(22) Filed: Aug. 12, 2011

(51) Int. Cl. H02K 5/24

(52) U.S. Cl. 310/51

(57) ABSTRACT

A generator collector ventilation system includes a ventilation inlet duct formed in a support foundation. The ventilation inlet duct has a first end that extends to a second end. The second end is configured and disposed to direct ventilation fluid into a generator collector housing. A ventilation outlet duct is formed in the support foundation. The ventilation outlet duct includes a first end portion that extends to a second end portion. The second end portion is configured and disposed to direct ventilation fluid from the generator collector housing. A silencer module is arranged in one of the ventilation inlet duct and the ventilation outlet duct. The silencer module is configured and disposed to condition the ventilation fluid passing through the generator collector housing to lower an overall noise signature of the generator collector ventilation system.

### BACKGROUND OF THE INVENTION

The subject matter disclosed herein relates to the art of generators and, more particularly, a silencer module for a generator collector ventilation system.

Many energy generation facilities employ generators driven by, for example, turbomachines. In many installations, the generators are mounted on a foundation in line with the turbomachine. Generators typically include a collector assembly within which are mounted brush assemblies that direct electrical energy to electrical windings of a rotating generator magnetic field. During operation, heat builds up in the collector assembly. Accordingly, the collector assembly is provided with ventilation system for cooling. Generally, the ventilation system includes passageways or ducts formed in the foundation. Typically, a first or supply duct delivers ventilating air to the collector assembly, and a second or exhaust duct passes the ventilating air along with dust from the brush assemblies to an exhaust outlet. Air passing through the collector assembly creates a considerable noise signature that passes through the ducts and adds to an overall sound footprint of the energy generation facility

### BRIEF DESCRIPTION OF THE INVENTION

According to one aspect of the exemplary embodiment, a generator collector ventilation system includes a ventilation inlet duct formed in a support foundation. The ventilation inlet duct has a first end that extends to a second end. The second end is configured and disposed to direct ventilation fluid into a generator collector housing. A ventilation outlet duct is formed in the support foundation. The ventilation outlet duct includes a first end portion that extends to a second end portion. The second end portion is configured and disposed to direct ventilation fluid from the generator collector housing. A silencer module is arranged in one of the ventilation inlet duct and the ventilation outlet duct. The silencer module is configured and disposed to condition the ventilation fluid passing through the generator collector housing to lower an overall noise signature of the generator collector ventilation system.

According to another aspect of the exemplary embodiment, an energy generation system includes a support foundation including a ventilation system having a ventilation inlet duct including a first end that extends to a second end, and a ventilation outlet duct including a first end portion that extends to a second end portion. A turbomachine is mounted to the support foundation, and a generator is mounted to the support foundation and operatively connected to the turbomachine. The generator includes a collector having a collector housing. The collector housing is positioned about the second end of the ventilation inlet duct and the second end portion of the ventilation outlet duct. A silencer module is arranged in one of the ventilation inlet duct and the ventilation outlet duct. The silencer module is configured and disposed to condition ventilation fluid passing through the generator collector housing to lower an overall noise signature of the generator collector ventilation system.

According to yet another aspect of the exemplary embodiment, a method of reducing a noise signature from a generator collector includes installing a first silencer module in one of a first end and a second end of a ventilation duct leading into a generator collector housing, and installing a second silencer module in one of a first end portion and a second end portion of a ventilation outlet duct leading out from the generator collector housing. The first and second silencer modules collectively reducing a noise signature from the generator collector.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification.

The foregoing and other features, and advantages of the invention are apparent from the following detailed description taken in conjunction with the accompanying drawings in which:

FIG. 1 is a perspective view of an energy generation system including a turbomachine and a generator having a collector coupled to a ventilation system provided with silencer modules in accordance with an exemplary embodiment;

FIG. 2 is a cross-sectional side view of the collector and ventilation system of FIG. 1 including silencer modules in accordance with one aspect of the exemplary embodiment;

FIG. 3 is a perspective view of the silencer module of FIG. 2;

FIG. 4 is a cross-sectional side view of the collector and ventilation system of FIG. 1 including silencer modules in accordance with another aspect of the exemplary embodiment;

FIG. 5 is a perspective view of the silencer module of FIG. 4;

FIG. 6 is a cross-sectional side view of the collector and ventilation system of FIG. 1 including a silencer module in accordance with yet another aspect of the exemplary embodiment;

FIG. 7 is a perspective view of the silencer module of FIG. 6; and

FIG. 8 is a cross-sectional side view of the collector and ventilation system of FIG. 1 illustrating silencer modules arranged in accordance with another aspect of the exemplary embodiment.

The detailed description explains embodiments of the invention, together with advantages and features, by way of example with reference to the drawings.

### DETAILED DESCRIPTION OF THE INVENTION

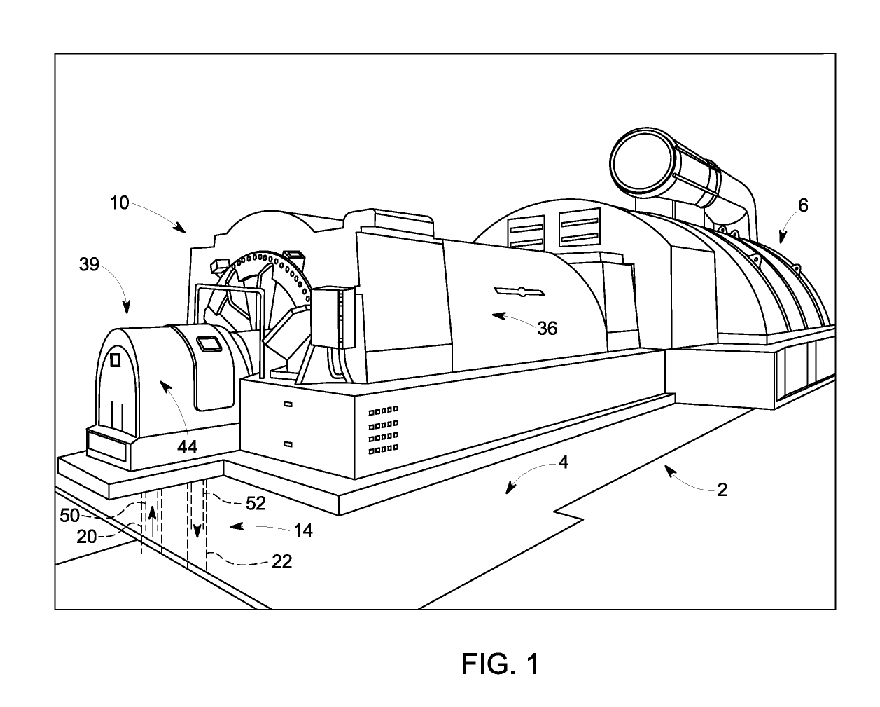

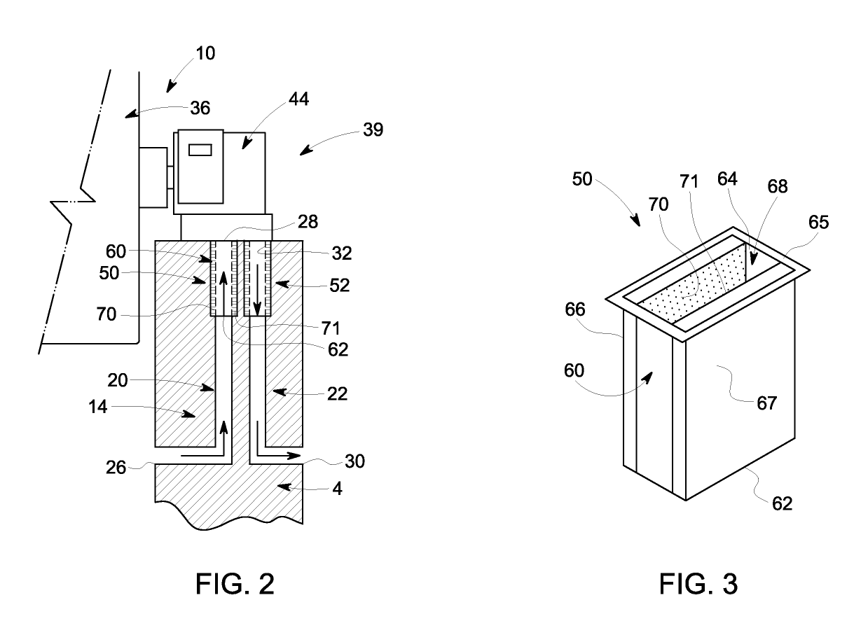

With reference to FIGS. 1 and 2, an energy generation system in accordance with an exemplary embodiment is indicated generally at 2. Energy generation system 2 includes a support foundation 4 that supports a turbomachine 6 and a generator 10. Support foundation 4 includes a generator ventilation system 14 having a ventilation inlet duct 20 and a ventilation outlet duct 22. Ventilation inlet duct 20 includes a first end 26 that extends through support foundation 4 to a second end 28. Similarly, ventilation outlet duct 22 includes a first end portion 30 that extends through support foundation 4 to a second end portion 32. Turbomachine 6 is operatively coupled to generator 10 along a centerline (not separately labeled). Generator 10 includes a generator housing 36 within which are arranged a stator (not shown) and a rotor (also not shown). The rotor is operatively coupled to a collector 39 that is arranged within a collector housing 44. Collector 39 includes brushes (not shown) that pass electrical energy into electrical windings of the rotating generator magnetic field (also not shown). Collector housing 44 is arranged about second end 28 of ventilation inlet duct 20 and second end portion 32 of ventilation outlet duct 22. With this arrangement, ventilation fluid, such as air, is passed through collector housing 44 to provide ventilation/cooling as well as carry away dust from the brushes.

In accordance with the exemplary embodiment, ventilation system 14 includes a first silencer module 50 arranged within ventilation inlet duct 20 at second end 28, and a second silencer module 52 arranged within ventilation outlet duct 22 at second end portion 32. As each silencer module 50, 52 is substantially similar, a detailed description will follow referencing FIG. 3 in describing first silencer module 50 with an understanding second silencer module 52 includes corresponding structure. Silencer module 50 includes a silencer body 60 having an inlet 62 and an outlet 64. Outlet 64 includes a flange 65 that supports silencer module 50 within ventilation inlet duct 20. In accordance with the exemplary aspect shown, inlet duct 20 includes a wider portion (not separately labeled) at second end 28 for receiving silencer module 50. Silencer module 50 also includes first and second side portions 66 and 67 that extend between inlet 62 and outlet 64 to define a flow passage 68. A first sound absorbing material 70 is arranged along first side portion 66 and a second sound absorbing material 71 is arranged along second side portion 67. Ventilation flow passing through silencer module 50 passes between first and second sound absorbing materials 70 and 71. Sound absorbing materials 70 and 71 muffle sound associated with ventilation flow passing through collector 39 and inlet duct 20. Similarly, second silencer module 52 muffles sound associated with ventilation flow passing through collector 39 and outlet duct 22. With this arrangement, first and second silencer modules 50 and 52 reduce an overall sound signature at collector 39 by conditioning ventilation flow passing into and out from collector housing 44.

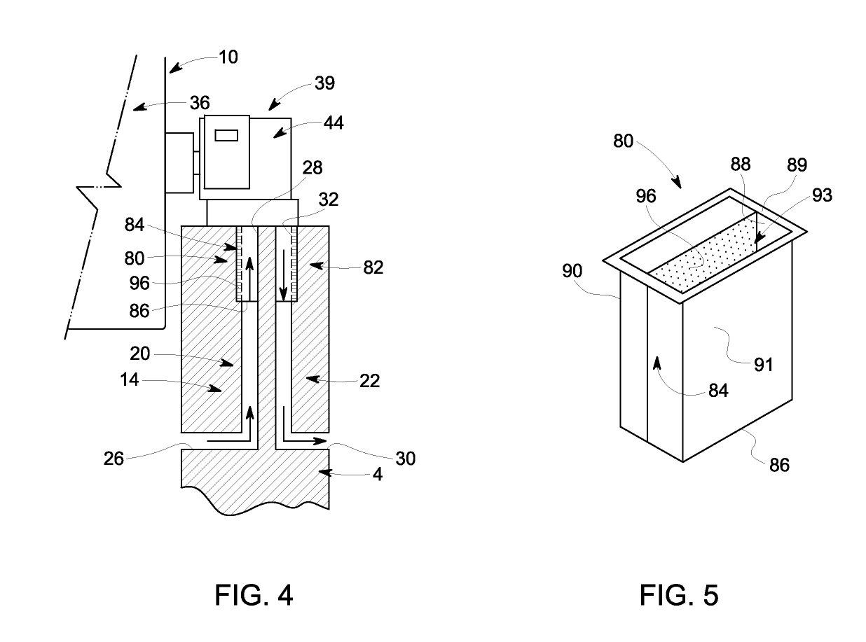

FIG. 4, wherein like reference numbers represent corresponding structure in the respective views, illustrates silencer modules 80 and 82 in accordance with another aspect of the exemplary embodiment. As each silencer module 80, 82 is similarly formed, a detailed description will follow to FIG. 5 in describing silencer module 80 with an understanding that silencer module 82 includes corresponding structure. Silencer module 80 includes a silencer body 84 having an inlet 86 and an outlet 88 including a flange 89. In a manner similar to that described above, flange 89 supports silencer module 80 within ventilation inlet duct 20. Silencer module 80 also includes first and second side portions 90 and 91 that define a flow passage 93. In the exemplary embodiment shown, silencer module 80 includes a sound absorbing material 96 only on first side portion 90. The sound absorbing material 96 muffles sound associated with ventilation flow passing though flow passage 93.

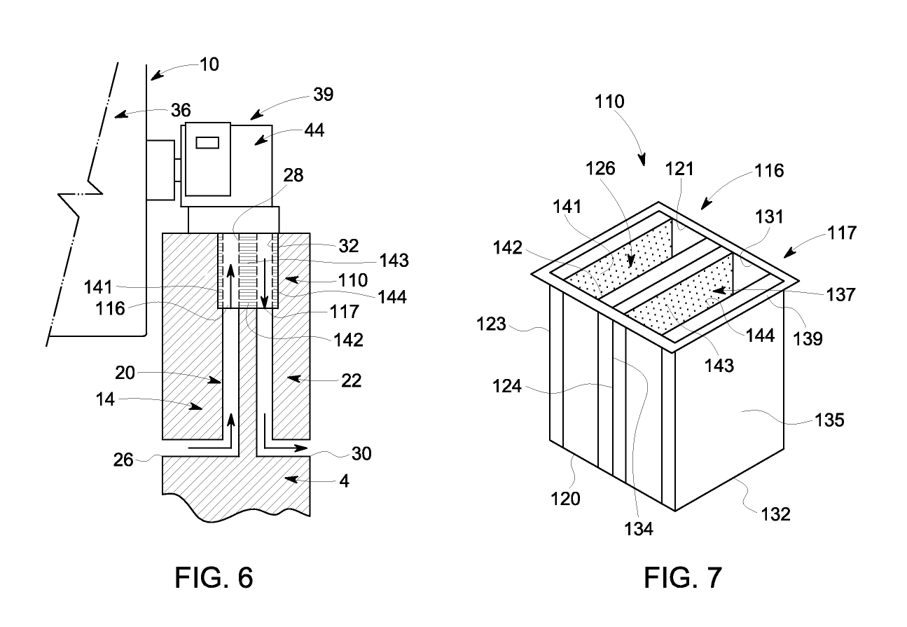

Reference will now be made to FIGS. 6 and 7, wherein like reference numbers represent corresponding structure in the respective views, in describing a double flow silencer module 110 in accordance with another exemplary embodiment. Double flow silencer module 110 includes a first or inlet flow portion 116 and a second or outlet flow portion 117. Inlet flow portion 116 includes an inlet 120 and an outlet 121 that are separated by first and second side portions 123 and 124 that establish a first flow passage 126. Second flow portion 117 includes an inlet 131 and an outlet 132 separated by first and second side sections 134 and 135 that establish a second flow passage 137. Inlet 131 is arranged adjacent to outlet 121 and outlet 132 is arranged adjacent to inlet 120. With this arrangement, ventilation flow passes through first flow portion 116 in a first direction into collector housing 44 and exits through second flow portion 117 in a second, opposite, direction. A flange 139 extends about first and second flow portions 116 and 117 to support double flow silencer module 110 within ventilation inlet duct 20 and ventilation outlet duct 22.

In further accordance with the exemplary aspect shown, double flow silencer module 110 includes a first sound absorbing material 141 that extends along first side portion 123; a second sound absorbing material 142 that extends along second side portion 124, a third sound absorbing material 143 that extends along first side section 134, and a fourth sound absorbing material 144 that extends along second side section 135. First and second sound absorbing materials 141 and 142 condition ventilation flow passing into collector housing 44, and third and fourth sound absorbing materials 143 and 144 condition ventilation flow passing from collector housing 44. With this arrangement, double flow silencer module 110 reduces an over all sound signature created by ventilation flow passing into and out from collector housing 44.

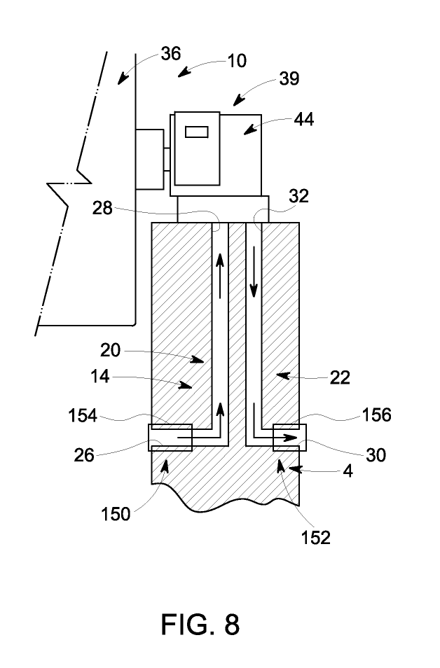

Reference will now be made to FIG. 8 in describing an alternative arrangement of silencer modules in accordance with another aspect of the exemplary embodiment. As shown, silencer modules 150 and 152 are arranged in first end 26 of ventilation inlet duct 20 and first end portion 30 of ventilation outlet duct 22 respectively. Silencer module 150 includes sound absorbing material 154, and silencer module 152 includes sound absorbing material 156. Silencer modules 150 and 152 are configured to reduce an overall sound signature of ventilation flow passing through collector housing 44. However, in contrast to the above described arrangements wherein the silencer modules are arranged within collector housing 44, silencer modules 150 and 152 are arranged at opposing ends of ventilation system 14.

At this point it should be understood that the exemplary embodiments describe silencer modules that condition a ventilation flow passing into and out from a generator collector housing. The silencer modules can be arranged within ventilation ducts in the collector housing, or at an opposing end of the ventilation ducts. It should also be understood that while described as being fitted into an expanded portion of ventilation ducts, the silencer modules can also be inserted into a duct having constant dimensions. Also, it should be understood, that the silencer ducts could include duct extensions that extend into the ventilation inlet duct and ventilation outlet duct respectively. Further, it should be understood that the inlet duct could be provided with a silencer support feature.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A generator collector ventilation system comprising:
a ventilation inlet duct formed in a support foundation, the ventilation inlet duct having a first end that extends to a second end, the second end being configured and disposed to direct ventilation fluid into a generator collector housing;
a ventilation outlet duct formed in the support foundation, the ventilation outlet duct including a first end portion that extends to a second end portion, the second end portion being configured and disposed to direct ventilation fluid from the generator collector housing; and
a silencer module arranged in one of the ventilation inlet duct and the ventilation outlet duct, the silencer module being configured and disposed to condition the ventilation fluid passing through the generator collector housing to lower an overall noise signature of the generator collector ventilation system.

2. The generator collector ventilation system according to claim 1, further comprising: another silencer module arranged in the other of the ventilation inlet duct and the ventilation outlet duct, the another silencer module being configured and disposed to condition the ventilation fluid passing through the generator collector housing to further lower an overall noise signature of the generator collector ventilation system.

3. The generator collector ventilation system according to claim 2, wherein the silencer module is arranged at the second end of the ventilation inlet duct, and the another silencer module is arranged at the second end portion of the ventilation outlet duct.

4. The generator collector ventilation system according to claim 2, wherein the silencer module is arranged at the first end of the ventilation inlet duct, and the another silencer module is arranged at the first end portion of the ventilation outlet duct.

5. The generator collector ventilation system according to claim 1, wherein the silencer module comprises a single flow silencer module having an inlet, an outlet, and first and second side portions extending between the inlet and the outlet, at least one of the first and second side portions including a sound absorbing material.

6. The generator collector ventilation system according to claim 5, wherein each of the first and second side portions includes a sound absorbing material.

7. The generator collector ventilation system according to claim 1, wherein the silencer module comprises a double flow silencer module including a first flow portion operatively connected to a second flow portion, the first flow portion being arranged in the ventilation inlet duct and a second flow portion being arranged in the ventilation outlet duct.

8. The generator collector ventilation system according to claim 7, wherein the first flow portion includes a first flow inlet, a first flow outlet and first and second side portions extending between the first flow inlet and first flow outlet, and the second flow portion includes a second flow inlet, a second flow outlet, and first and second side sections extending between the second flow inlet and the second flow outlet.

9. The generator collector ventilation system according to claim 8, wherein the second flow inlet is arranged adjacent the first flow outlet, and a second flow outlet arranged adjacent the first flow inlet.

10. The generator collector ventilation system according to claim 8, wherein at least one of the first and second side portions and the first and second side sections includes a sound absorbing material.

11. The generator collector ventilation system according to claim 8, wherein each of the first and second side portions and the first and second side sections includes a sound absorbing material.

12. An energy generation system comprising:
a support foundation including a ventilation system having a ventilation inlet duct including a first end that extends to a second end, and a ventilation outlet duct including a first end portion that extends to a second end portion;
a turbomachine, mounted to the support foundation;
a generator mounted to the support foundation and operatively connected to the turbomachine, the generator including a collector having a collector housing, the collector housing being positioned about the second end of the ventilation inlet duct and the second end portion of the ventilation outlet duct; and
a silencer module arranged in one of the ventilation inlet duct and the ventilation outlet duct, the silencer module being configured and disposed to condition ventilation fluid passing through the generator collector housing to lower an overall noise signature of the generator collector ventilation system.

13. The generator collector ventilation system according to claim 12, further comprising: another silencer module arranged in the other of the ventilation inlet duct and the ventilation outlet duct, the another silencer module being configured and disposed to condition the ventilation fluid passing through the generator collector housing to further lower an overall noise signature of the generator collector ventilation system.

14. The generator collector ventilation system according to claim 13, wherein the silencer module is arranged at the second end of the ventilation inlet duct, and the another silencer module is arranged at the second end portion of the ventilation outlet duct.

15. The generator collector ventilation system according to claim 13, wherein the silencer module is arranged at the first end of the ventilation inlet duct, and the another silencer module is arranged at the first end portion of the ventilation outlet duct.

16. The generator collector ventilation system according to claim 12, wherein the silencer module comprises a single flow silencer module having an inlet, an outlet, and first and second side portions extending between the inlet and the outlet, at least one of the first and second side portions including a sound absorbing material.

17. The generator collector ventilation system according to claim 12, wherein the silencer module comprises a double flow silencer module including a first flow portion operatively connected to a second flow portion, the first flow portion being arranged in the ventilation inlet duct and a second flow portion being arranged in the ventilation outlet duct.

18. The generator collector ventilation system according to claim 17, wherein the first flow portion includes a first flow inlet, a first flow outlet and first and second side portions extending between the first flow inlet and first flow outlet, and the second flow portion includes a second flow inlet, a second flow outlet, and first and second side sections extending between the second flow inlet and the second flow outlet.

19. The generator collector ventilation system according to claim 18, wherein the second flow inlet is arranged adjacent the first flow outlet, and a second flow outlet arranged adjacent the first flow inlet.

20. The generator collector ventilation system according to claim 18, wherein at least one of the first and second side portions and the first and second side sections includes a sound absorbing material.
